(19) United States
(12) Patent Application Publication
(10) Pub. No.: US 2026/0268844 A1
(43) Pub. Date: Sep. 10, 2026

(54) DISPLAY DEVICE AND CONTROL METHOD THEREOF

(71) Applicant: SAMSUNG ELECTRONICS CO., LTD., Suwon-si (KR)

(72) Inventors: Sungjin LIM, Suwon-si (KR); Jihye KIM, Suwon-si (KR)

(73) Assignee: SAMSUNG ELECTRONICS CO., LTD., Suwon-si (KR)

(21) Appl. No.: 19/674,928

(22) Filed: May 12, 2026

Related U.S. Application Data
(63) Continuation of application No. PCT/KR2024/010628, filed on Jul. 23, 2024.

(30) Foreign Application Priority Data
Nov. 29, 2023 (KR) 10-2023-0170178

(51) Int. Cl. G09G 3/3225

(52) U.S. Cl. CPC G09G 3/3225; G09G 2330/022; G09G 2370/16

(57) ABSTRACT

A display device includes a display panel, a display driver electrically connected to the display panel, a panel processor that transmits a driving signal to the display driver, and a power supply that supplies power to the display panel, the display driver, and the panel processor. The panel processor controls the power supply to maintain power supplied to the display panel and reduce power supplied to at least one of the display driver or the panel processor in an always on display (AOD) mode.

### CROSS-REFERENCE TO RELATED APPLICATION(S)

This application is a continuation of International Application No. PCT/KR2024/010628, filed on Jul. 23, 2024, which is based on and claims priority to Korean Patent Application No. 10-2023-0170178, filed Nov. 29, 2023, the disclosures of which are incorporated by reference herein in their entireties.

### BACKGROUND

### 1. Field

The disclosure relates to a display device for displaying an image in an always on display (AOD) mode, and a method for controlling the display device.

### 2. Description of Related Art

As display devices, liquid crystal display (LCD) devices, organic light-emitting diode (OLED)-based display devices, mini LED-based display devices, and micro LED-based display devices are widely used.

Among these, an OLED-based display device may continuously display information such as time, date, battery level, or notifications through a display panel during a sleep mode, which is referred to as an always on display (AOD) mode. That is, the AOD mode allows a user to check information such as time, date, battery level, or notifications on the display panel while the display device is in the sleep mode.

To display an image even in the AOD mode, the OLED-based display device supplies power to various components of the display device, thereby causing increased power consumption during the AOD mode.

### SUMMARY

An aspect of the disclosure provides a display device that maintains power supplied to a display panel while reducing power supplied to a panel processor and a display driver based on an always on display (AOD) mode, and a method for controlling the display device.

Another aspect of the disclosure provides a display device that restores power supplied to a panel processor and a display driver based on an update mode for updating an image displayed in an AOD mode, and a method for controlling the display device.

Still another aspect of the disclosure provides a display device that displays an image at a first frame rate based on a normal display mode and displays an image at a second frame rate based on an AOD mode, and a method for controlling the display device.

According to an aspect of the disclosure, there is provided a display device, including: a display panel; a display driver electrically connected to the display panel; a panel processor configured to transmit a driving signal to the display driver; and a power supply configured to supply power to the display panel, the display driver, and the panel processor, wherein the panel processor is configured to control the power supply to maintain power supplied to the display panel and reduce power supplied to at least one of the display driver or the panel processor in an always on display (AOD) mode.

The panel processor may include: a first processor configured to receive an image signal from an external device; and a second processor configured to convert the image signal received by the first processor into the driving signal for each pixel and transmit the converted driving signal for each pixel to the display driver.

The first processor may include a central processing unit configured to perform signal processing on the image signal received from the external device, a display controller configured to control transmission of the received image signal, a first communication interface configured to transmit the received image signal to the second processor, and a first power controller configured to control power supplied to the central processing unit, the display controller, and the first power controller, and wherein the first power controller may be configured to receive power from the power supply and block power supplied to the central processing unit, the display controller, and the first power controller in the AOD mode.

The second processor may include a second communication interface configured to communicate with the first processor, a low-power memory configured to store an image, an image processor configured to perform image processing on the received image, a timing controller configured to control operation timing of the low-power memory and the image processor, and a second power controller configured to control power supplied to the second communication interface, the low-power memory, the image processor, and the timing controller, and wherein the second power controller may be configured to receive power from the power supply and block power supplied to the second communication interface, the low-power memory, the image processor, and the timing controller in the AOD mode.

The second power controller may be configured to supply a reference power to the display driver in the AOD mode, and wherein the reference power may be power that provides a luminance of the display panel at a reference luminance in the AOD mode.

The second processor may be configured to control transmission of an image stored in the low-power memory to the display driver based on power supplied to the first processor being reduced.

The first power controller may be configured to maintain power supplied to the central processing unit, the display controller, and the first power controller during the AOD mode, based on setting ON information of a voice recognition mode.

The panel processor may be configured to: control the display driver to output the received image at a first frame rate based on a normal display mode, and control the display driver to output the received image at a second frame rate based on the AOD mode, wherein a frequency corresponding to the second frame rate may be less than or equal to a frequency corresponding to the first frame rate.

The panel processor may be configured to: control the power supply to restore power supplied to the display driver and the panel processor, based on a timing for entering an update mode for updating an image displayed in the AOD mode being reached, and control the display driver to output the received image at the second frame rate based on the update mode.

The display device may include: communication circuitry configured to communicate with a user device and a home appliance, wherein the panel processor may be configured to determine that the timing for entering the update mode is reached based on receiving a communication signal from the user device, and determine that the timing for entering the update mode is reached based on receiving event information from the home appliance.

The display panel may be configured to control a pixel shift during the update mode.

The panel processor may be configured to determine whether a timing for entering a blank mode is reached during the AOD mode, and control the display driver to output a pre-stored image at a third frame rate based on determining that the timing for entering the blank mode is reached, wherein a frequency corresponding to the third frame rate is less than the frequency corresponding to the first frame rate and the frequency corresponding to the second frame rate.

According to an aspect of the disclosure, there is provided a method for controlling a display device, including: based on an entry into an always on display (AOD) mode, reducing power supplied to at least one of a display driver or a panel processor and maintaining power supplied to a display panel; based on an entry into an update mode, restoring power supplied to at least one of a first processor, a second processor, or the display driver, and maintaining power supplied to the display panel; transmitting, by the first processor, an image signal received from an external device to the second processor; converting, by the second processor, the image signal into a driving signal, and transmitting the driving signal to the display driver; and transmitting, by the display driver, the driving signal to the display panel.

The method may include: outputting the image signal at a first frame rate based on a normal display mode; outputting the image signal at a second frame rate based on the AOD mode; and outputting the image signal at the second frame rate based on the update mode, wherein a frequency corresponding to the second frame rate may be less than or equal to a frequency corresponding to the first frame rate.

The method may include: determining an entry into a blank mode during the AOD mode; and outputting the image signal at a third frame rate based on the entry into the blank mode, wherein a frequency corresponding to the third frame rate may be less than the frequencies corresponding to the first frame rate and the second frame rate.

According to an aspect of the disclosure, a display device may reduce power supplied to at least one of a panel processor or a display driver in an always on display (AOD) mode, thereby reducing power consumption.

According to an aspect of the disclosure, power consumed in an AOD mode may be minimized by updating an image displayed in the AOD mode based on recognition of a user during the AOD mode.

According to an aspect of the disclosure, the display device may provide a user with various information in an AOD mode by displaying not only information about weather, date, and time, but also news, operation information of other home appliances in a home, and schedule information of a user device via the AOD mode of the display device.

According to an aspect of the disclosure, the display device may display guide information for a broadcasting program and over-the-top (OTT) content information in an AOD mode, thereby encouraging viewing by a user.

According to an aspect of the disclosure, the display device may maintain a luminance of a display panel at a reference luminance during an AOD mode, thereby preventing occurrence of an afterimage while ensuring user visibility.

According to an aspect of the disclosure, occurrence of an afterimage may be minimized by performing a pixel shift during an AOD mode.

Marketability and competitiveness of the display device may be improved, and user satisfaction and reliability may be increased.

### BRIEF DESCRIPTION OF THE DRAWINGS

The above and other aspects and/or features of embodiments of the disclosure will become more apparent from the following detailed description taken in conjunction with the accompanying drawings, in which:

FIG. 1 is a diagram of a home network system including a display device according to an embodiment.

FIG. 2 is an exemplary view of a display device according to an embodiment.

FIG. 3 is an exemplary view of a display panel provided in a display device according to an embodiment.

FIG. 4 is an exemplary view of an organic light-emitting device provided in a display device according to an embodiment.

FIG. 5 is a control block diagram of a display device according to an embodiment.

FIG. 6 is an exemplary view of a pixel driving circuit provided in a display device according to an embodiment.

FIG. 7 is a detailed configuration diagram of a panel processor and a display driver of a display device according to an embodiment.

FIG. 8 is a detailed configuration diagram of a first processor of a display device according to an embodiment.

FIG. 9 is an exemplary view of a frame rate of an image displayed in an always on display (AOD) mode of a display device according to an embodiment.

FIG. 10 is a detailed configuration diagram of a second processor of a display device according to an embodiment.

FIG. 11 is a table for power consumption of a display device according to an embodiment.

FIG. 12 is a flowchart illustrating a method for controlling a display device according to an embodiment.

FIG. 13 is a power control table of a first processor, a second processor, a display driver, and a display panel for each mode of a display device according to an embodiment.

FIG. 14A and FIG. 14B are views illustrating examples of an image displayed in an AOD mode of a display device according to an embodiment.

### DETAILED DESCRIPTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

As used herein, the term “and/or” includes any and all combinations of one or more of the associated listed items.

Hereinafter, the principles of operation and embodiments of the disclosure will be described with reference to the accompanying drawings.

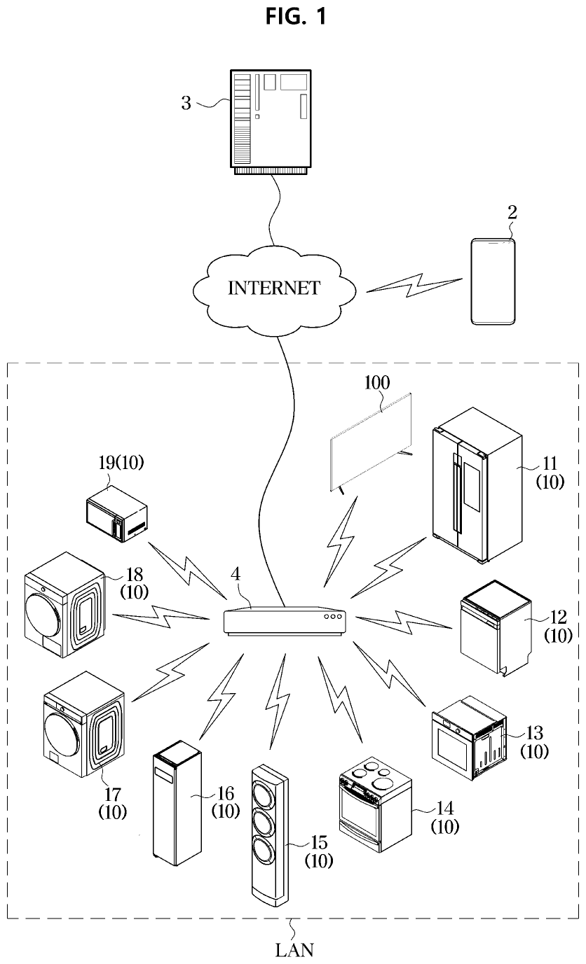

FIG. 1 is a diagram of a home network system including a display device according to an embodiment.

A home appliance 10 may include a communication module capable of communicating with another home appliance, a user device 2, or a server 3, a user interface that receives a user input or outputs information to a user, at least one processor that controls an operation of the home appliance 10, and at least one memory that stores a program for controlling the operation of the home appliance 10.

The home appliance 10 may be at least one of various types of home appliances. For example, as shown in the accompanying drawings, the home appliance 10 may include a refrigerator 11, a dishwasher 12, an electric range 13, an electric oven 14, an air conditioner 15, a clothes treating apparatus 16, a washing machine 17, a dryer 18, and a microwave oven 19, but is not limited thereto. For example, the home appliance 10 may include various types of appliances not shown in the drawings, such as a cleaning robot, a vacuum cleaner, a display device 100 like a television, and the like. Furthermore, the aforementioned home appliances are by way of example only, and in addition to the aforementioned home appliances, other appliances connected to other home appliance, the user device 2, or the server 3 to perform operations described below may be included in the home appliance 10 according to an embodiment.

The server 3 may include a communication module communicating with another server, the home appliance 10, or the user device 2, at least one processor that processes data received from another server, the home appliance 10, or the user device 2, and at least one memory that stores programs for processing data or processed data. The server 3 may be implemented as a variety of computing devices, such as a workstation, a cloud, a data drive, a data station, and the like. The server 3 may be implemented as one or more server physically or logically separated based on a function, detailed configuration of function, or data, and may transmit and receive data through communication between servers and process the transmitted and received data.

The server 3 may perform functions, such as managing a user account, registering the home appliance 10 in association with the user account, managing or controlling the registered home appliance 10, and the like. For example, a user may access the server 3 via the user device 2 and may create a user account. The user account may be identified by an identifier (ID) and a password set by the user.

The server 3 may register the home appliance 10 with the user account according to a predetermined procedure. For example, the server 3 may link identification information of the home appliance 10 (e.g., a serial number or MAC address) to the user account to register, manage, and control the home appliance 10. The user device 2 may include a communication module capable of communicating with the server 3, a user interface that receives a user input or outputs information to a user, at least one processor that controls an operation of the user device 2, and at least one memory that stores a program for controlling the operation of the user device 2.

The user device 2 may be carried by a user, or placed in a user's home or office, or the like. The user device 2 may include a personal computer (PC), a terminal, a portable telephone, a smartphone, a handheld device, a wearable device, and the like, but is not limited thereto.

The memory of the user device 2 may store a program for controlling the home appliance 10, i.e. an application. The application may be sold installed on the user device 2, or may be downloaded from an external server for installation.

By running the application installed on the user device 2 by a user, the user may access the server 3, create a user account, and communicate with the server 3 based on the login user account to register the home appliance 10.

For example, by operating the home appliance 10 to allow the home appliance 10 to access the server 3 according to a procedure guided by the application installed on the user device 2, the server 3 may register the home appliance 10 with the user account by assigning the identification information (e.g., a serial number or a MAC address) of the home appliance 10 to the corresponding user account.

A user may control the home appliance 10 using the application installed on the user device 2. For example, by logging into a user account with the application installed on the user device 2, the home appliance 10 registered in the user account appears, and by inputting a control command for the home appliance 10, the control command may be delivered to the home appliance 10 via the server 3.

A network may include both a wired network and a wireless network. The wired network may include a cable network or a telephone network, and the wireless network may include any networks transmitting and receiving a signal via radio waves. The wired network and the wireless network may be interconnected.

The network may include a wide area network (WAN), such as the Internet, a local area network (LAN) formed around an access point (AP), and a short-range wireless network that does not use an AP. The short-range wireless network may include Bluetooth™ (IEEE 802.15.1), Zigbee (IEEE 802.15.4), Wi-Fi Direct, near field communication (NFC), and Z-Wave, but is not limited thereto.

The AP may connect the home appliance 10 or the user device 2 to a WAN connected to the server 3. The home appliance 10 or the user device 2 may be connected to the server 3 via a WAN.

The AP may communicate with the home appliance 10 or the user device 2 using wireless communication, such as Wi-Fi™ (IEEE 802.11), Bluetooth™ (IEEE 802.15.1), Zigbee (IEEE 802.15.4), and the like, and access a WAN using wired communication, but is not limited thereto.

According to various embodiments, the home appliance 10 may be directly connected to the user device 2 or the server 3 without going through an AP.

The home appliance 10 may be connected to the user device 2 or the server 3 via a long-range wireless network or a short-range wireless network.

For example, the home appliance 10 may be connected to the user device 2 via a short-range wireless network (e.g., Wi-Fi Direct).

In another example, the home appliance 10 may be connected to the user device 2 or the server 3 via a WAN using a long-range wireless network (e.g., a cellular communication module).

In still another example, the home appliance 10 may access a WAN using wired communication, and may be connected to another home appliance 10 or the server 3 via a WAN.

When accessing a WAN using wired communication, the home appliance 10 may also act as an AP. Accordingly, the home appliance 10 may connect another home appliance 10 to a WAN to which the server 3 is connected. In addition, another home appliance 10 may connect the home appliance 10 to the WAN to which the server 3 is connected.

The home appliance 10 may transmit information about an operation or state to other home appliances, the user device 2, or the server 3 via the network. For example, the home appliance 10 may transmit information about an operation or state to other home appliances, the user device 2 or the server 3 upon receiving a request from the server 3, in response to an event in the home appliance 10, or periodically or in real time.

Upon receiving the information about the operation or state from the home appliance 10, the server 3 may update the stored information about the operation or state of the home appliance 10 and transmit the updated information about the operation and state of the home appliance 10 to the user device 2 via the network. Here, updating the information may include various operations in which existing information is changed, such as adding new information to the existing information, replacing the existing information with new information, and the like.

The home appliance 10 may obtain various information from other home appliances, the user device 2, or the server 3, and may provide the obtained information to a user. For example, the home appliance 10 may obtain information related to a function of the home appliance 10 (e.g., recipes, washing instructions, display modes, etc.) from the server 3 and various environmental information (e.g., weather, temperature, humidity, etc.), and may output the obtained information via a user interface.

The home appliance 10 may operate in accordance with a control command received from other home appliances, the user device 2, or the server 3. For example, the home appliance 10 may operate in accordance with a control command received from the server 3, based on a prior authorization obtained from a user to operate in accordance with the control command of the server 3 even without a user input. Here, the control command received from the server 3 may include a control command input by the user via the user device 2 or a control command based on preset conditions, but is not limited thereto.

The user device 2 may transmit information about a user to the home appliance 10 or the server 3 via the communication module. For example, the user device 2 may transmit information about a user's location, a user's health condition (i.e., state), a user's preference, a user's schedule, and the like to the server 3. The user device 2 may transmit information about the user to the server 3 based on the user's prior authorization.

The home appliance 10, the user device 2, or the server 3 may use techniques, such as artificial intelligence (AI) to determine a control command. For example, the server 3 may receive information about an operation or a state of the home appliance 10 or information about a user of the user device 2, process the received information using techniques, such as AI, and transmit a processing result or a control command to the home appliance 10 or the user device 2 based on the processing result.

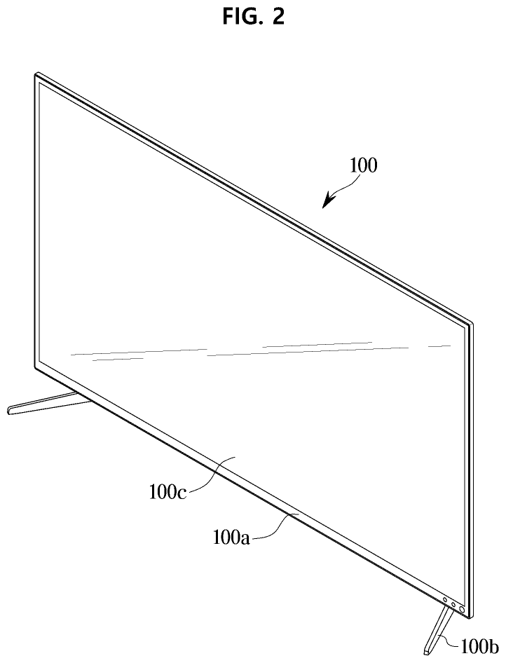

FIG. 2 is an exemplary view of a display device according to an embodiment.

The display device 100 is a device that displays visual and stereoscopic image information, such as a display portion of a mobile device like a laptop, a smartphone, a tablet, etc., a monitor of a personal computer (PC), a television, a display portion of a home appliance, a display portion in a vehicle, and the like.

In an embodiment, a television among the display devices 100 is described.

As shown in FIG. 2, the display device 100 includes a main body 100a forming an exterior, and a stand 100b mounted at a lower end of the main body 100a. The display device 100 may also be installed on a wall by a bracket, or the like, without a stand.

The display device 100 may include a display panel 100c that is provided in the main body 100a and displays an image.

The main body 100a may include a cover that covers the rear surface of the display panel 100c.

The main body 100a may further include a bezel that covers the edge of the display panel 100c. In this case, the cover and the bezel of the main body may be detachably coupled to each other.

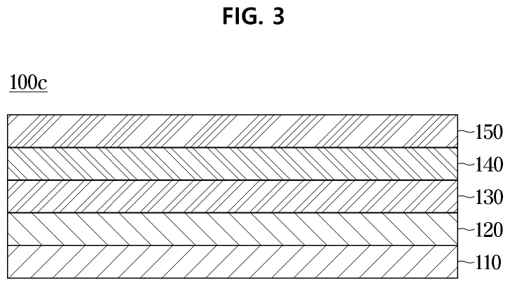

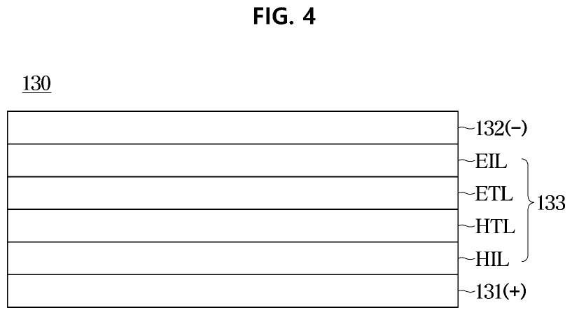

FIG. 3 is an exemplary view of the display panel of the display device according to an embodiment, which is described with reference to FIG. 4. FIG. 4 is an exemplary view of an organic light-emitting device provided in the display device according to an embodiment.

Among display devices, a display panel of an organic light-emitting diode (OLED)-based display device is described.

As shown in FIG. 3, the display panel 100c of the display device 100 may include a base substrate 110, a driving substrate 120, an organic light-emitting substrate 130, an encapsulation substrate 140, and a polarizer plate 150.

The base substrate 110 may be a transparent insulating substrate made of glass, quartz, ceramics, or the like. The base substrate 110 may be a transparent flexible substrate made of plastic, or the like.

The driving substrate 120 may be arranged on the base substrate 110.

The driving substrate 120 may be electrically and physically connected to the organic light-emitting substrate 130.

The driving substrate 120 may include a thin film transistor (TFT) circuit substrate that transmits a driving signal for driving a plurality of organic light-emitting devices provided on the organic light-emitting substrate 130. The TFT circuit substrate may include a plurality of transistors and a plurality of capacitors.

The plurality of transistors may be formed of an oxide.

The organic light-emitting substrate 130 may display an image by emitting light according to a driving signal received from the driving substrate 120. Light generated in the organic light-emitting substrate 130 may be emitted to the outside through the encapsulation substrate 140.

As shown in FIG. 4, the organic light-emitting substrate 130 may include a first electrode 131, a second electrode 132, and a plurality of organic light-emitting devices 133.

The first electrode 131 and the second electrode 132 include at least one of a transparent conductive material or a semi-transmissive metal.

The transparent conductive material includes at least one of indium tin oxide (ITO), indium zinc oxide (IZO), zinc oxide (ZnO), or indium oxide (In₂O₃).

The semi-transmissive metal may be a metal made of one or more metals of magnesium (Mg), silver (Ag), gold (Au), calcium (Ca), lithium (Li), chromium (Cr), and aluminum (Al), or an alloy thereof.

The first electrode 131 may be an anode electrode which is a hole-injection electrode, and the second electrode 132 may be a cathode electrode which is an electron-injection electrode.

Each organic light-emitting device 133 may include at least one of an emitting layer (EML), a hole-injection layer (HIL), a hole-transporting layer (HTL), an electron-transporting layer (ETL), or an electron-injection layer (EIL).

Among the aforementioned layers, the remaining layers except for the emitting layer may be omitted as required.

In a case where each organic light-emitting device 133 includes all of the aforementioned layers, the HIL may be disposed on the first electrode 131, and the HTL, the EML, the ETL, and the EIL may be sequentially stacked thereon.

The EML may include an organic material. As usable organic materials, various materials including copper phthalocyanine (CuPc), N,N′-Di(naphthalene-1-yl)-N,N′-diphenyl-benzidine (NPB), tris-8-hydroxyquinoline aluminum (Alq3), and the like, may be used.

The organic light-emitting substrate 130 may further include a polarizing film (not shown) provided on the second electrode 132 and having a polarization axis. The polarizing film may transmit light aligned with the polarization axis and reflect light not aligned with the polarization axis. Thus, light that has passed through the polarizing film may be linearly polarized in a direction of the polarization axis of the polarizing film.

The encapsulation substrate 140 seals the organic light-emitting substrate 130 and the driving substrate 120.

The encapsulation substrate 140 may be made of a glass substrate, a substrate of various plastic materials such as acrylic, or a metal plate.

The polarizer plate 150 may be arranged on the encapsulation substrate 140. The polarizer plate 150 serves to block external light reflection.

The polarization axis of the polarizer plate 150 may be the same as that of the polarizing film of the organic light-emitting device 130.

The polarizer plate 150 may also be arranged between the encapsulation substrate 140 and the organic light-emitting substrate 130.

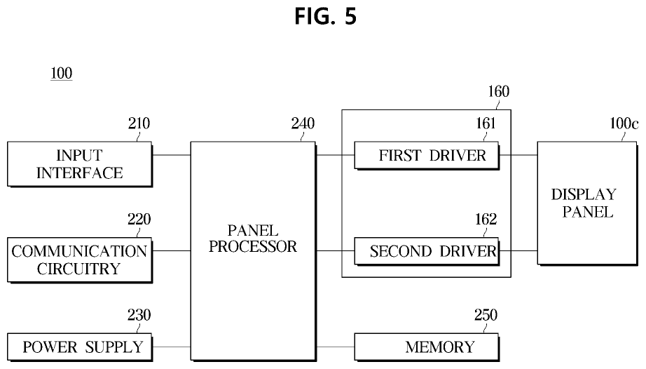

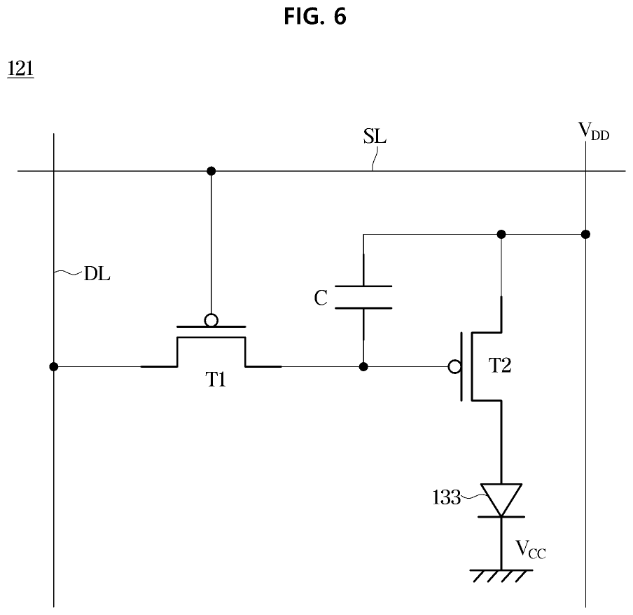

FIG. 5 is a control block diagram of a display device according to an embodiment, which is described with reference to FIGS. 6, 7, 8, 9, 10, and 11.

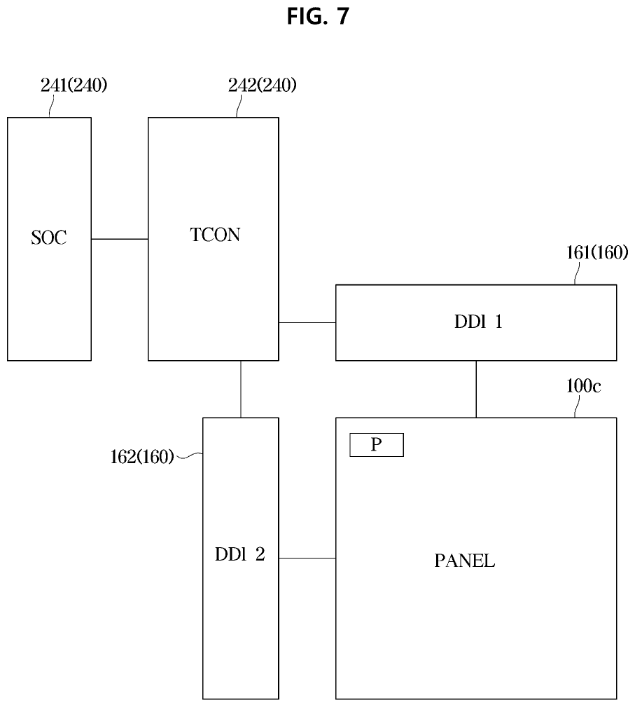

FIG. 6 is an exemplary view of a pixel driving circuit provided in the display device according to an embodiment, and FIG. 7 is a detailed configuration diagram of a panel processor and a display driver of the display device according to an embodiment.

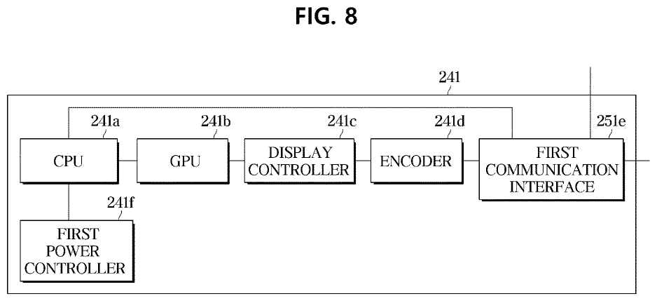

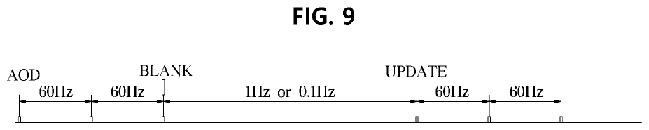

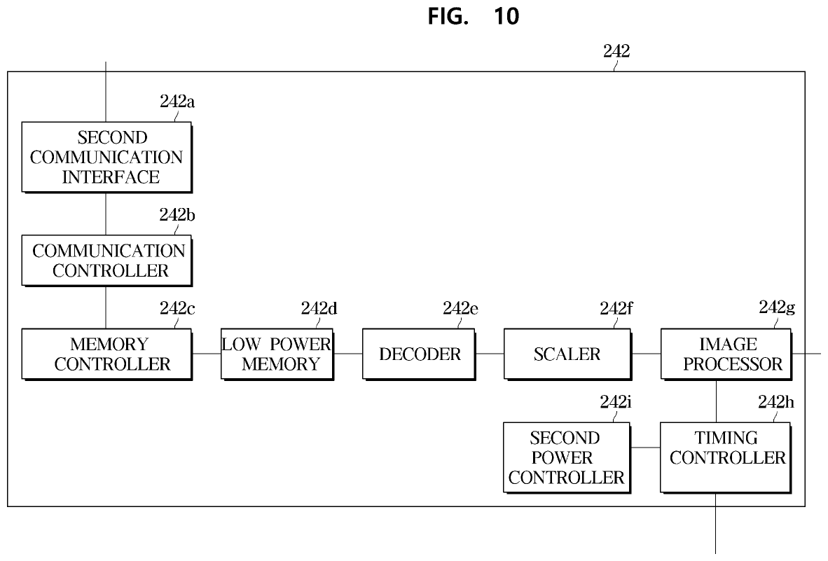

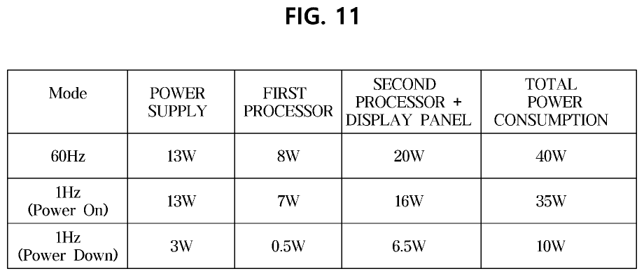

FIG. 8 is a detailed configuration diagram of a first processor of the display device according to an embodiment, FIG. 9 is an exemplary view of a frame rate of an image displayed in an always on display (AOD) mode of the display device according to an embodiment, and FIG. 10 is a detailed configuration diagram of a second processor of the display device according to an embodiment. FIG. 11 is a table for power consumption of the display device according to an embodiment.

As shown in FIG. 5, the display device 1 may include the display panel 100c, a display driver 160, an input interface 210, communication circuitry 220, a power supply 230, a panel processor 240, and a memory 250.

The structure of the display panel 100c has been described with reference to FIG. 3 and FIG. 4, and thus description thereof will be omitted.

The display panel 100c may include a plurality of pixels.

Each pixel may include a first sub-pixel, a second sub-pixel, and a third sub-pixel. Here, the first sub-pixel may correspond to a first organic light-emitting device that emits red light, the second sub-pixel may correspond to a second organic light-emitting device that emits green light, and the third sub-pixel may correspond to a third organic light-emitting device that emits blue light.

The display panel 100c may include a plurality of pixel driving circuits 121 corresponding to each organic light-emitting device 133. The plurality of pixel driving circuits 121 may be provided on the driving substrate 120.

As shown in FIG. 6, each pixel driving circuit 121 may include a first transistor T1, a second transistor T2, and a capacitor C.

A gate terminal of the first transistor T1 may be connected to a scan line SL, and a drain terminal of the first transistor T1 may be connected to a data line DL.

A source terminal of the first transistor T1 may be connected to a gate terminal of the second transistor T2.

The capacitor C may be arranged between the gate terminal and a drain terminal of the second transistor T2. The organic light-emitting device 133 may be connected to a source terminal of the second transistor T2.

The drain terminal of the second transistor T2 may be connected to a power line (V_{DD}).

The data line DL may be a line through which main power of the pixel driving circuit is supplied.

The scan line SL is a gate line, which allows current to be supplied to the second transistor T2.

Electrons may be stored in the capacitor C to which current is supplied by the second transistor T2.

Current may flow through the organic light-emitting device 133 as the second transistor T2 is turned on.

The scan line may be provided to cross the data line. In this case, a crossing point of the scan line and the data line may correspond to a sub-pixel.

Current flowing through the organic light-emitting device 133 may indicate that current flows through the sub-pixel.

Each sub-pixel may emit light with brightness corresponding to an amount of current flowing through the sub-pixel.

The pixel driving circuit is not limited to the pixel driving circuit shown in FIG. 6. That is, in addition to the pixel driving circuit structure shown in FIG. 6, the pixel driving circuit structure may also be implemented as a circuit of a different structure.

The display driver 160 (also referred to as a display driver integrated circuit (DDI)) may be connected to the display panel 100c.

The display driver 160 may receive a driving signal for displaying an image from the panel processor 240, and may transmit the received driving signal to the display panel 100c.

The driving signal for displaying an image may include a scan signal and a data signal.

The display driver 160 may include a first driver 161 and a second driver 162.

The first driver 161 may include the data line DL. The first driver 161 may be connected to the driving substrate 120 of the display panel 100c through the data line DL. The data line DL of the first driver 161 may be connected to the drain terminal of the first transistor T1 of the pixel driving circuit 121.

The first driver 161 may transmit a data signal to the driving substrate 120 of the display panel 100c through the data line DL, i.e., to a plurality of pixel driving circuits of the driving substrate.

The data signal may be a signal that defines a difference in color to be displayed by the sub-pixel.

The first driver 161 may include a first display driver integrated circuit (DDI).

The first DDI is also referred to as a source driver integrated circuit.

The second driver 162 may include the scan line SL. The second driver 162 may be connected to the driving substrate 120 of the display panel 100c through the scan line SL.

The scan line SL of the second driver 162 may be connected to the gate terminal of the first transistor T1 of the pixel driving circuit 121.

The second driver 162 may transmit a scan signal to the driving substrate 120 of the display panel 100c through the scan line SL, i.e., to a plurality of pixel driving circuits of the driving substrate.

The second driver 162 may include a second display driver integrated circuit (DDI).

The second DDI is also referred to as a gate driver integrated circuit.

The first driver 161 may allow power supplied to the first driver 161 to be maintained during a normal display mode, and allow power supplied to the first driver 161 to be reduced based on a blank mode during an AOD mode.

The normal display mode may be a mode for displaying an image received from an external device in real time, and displaying a moving image.

The AOD mode is a mode for displaying a still image while in a sleep mode.

The second driver 162 may allow power supplied to the second driver 162 to be maintained during the normal display mode, and allow power supplied to the second driver 162 to be reduced based on the blank mode during the AOD mode.

The blank mode may be a mode in which transmission of an image frame for a still image is stopped and a black image is displayed.

The first and second drivers 161 and 162 whose power is reduced may apply a reference voltage to thin film transistors. Through the above, the display device may minimize occurrence of an afterimage of the display panel while improving visibility in the AOD mode.

The reference voltage may be a voltage corresponding to a reference luminance. The reference luminance may be any luminance from 40 to 100 nits.

As a voltage applied to a plurality of pixels of the display panel increases, an amount of current increases. In this instance, luminance and temperature of the pixels increase, causing deterioration of the pixels and occurrence of an afterimage.

Accordingly, the first and second drivers 161 and 162 may allow the AOD mode to be operated at the reference luminance that may minimize occurrence of an afterimage and ensure visibility.

The thin film transistors of the driving substrate of the display panel 100c are formed of an oxide, and may maintain image data for a longer time for the blank mode than thin film transistors formed of other materials.

Power of the display driver 160 may also be controlled by the panel processor 240.

The display driver 160 may include a power controller (not shown), and power supplied to various components of the first and second drivers 161 and 162 may be controlled by the power controller.

The input interface 210 may receive a user input.

The user input may include a mode switching command from a sleep mode to a wake-up mode, and a mode switching command from a normal mode to a sleep mode.

The user input may include selection information for an external device and selection information for content.

The user input may include on/off information indicating whether the AOD mode is operated, selection information for an image to be displayed in the AOD mode, and selection information for a notification to be displayed in the AOD mode.

The image to be displayed in the AOD mode may be a still image, and may include photos, emoticons, and the like.

The notification may include a notification for an event of the home appliance, a notification for news, a notification for a schedule, a notification for new content, a notification for a broadcasting program, and the like.

The user input may include on/off information indicating whether a user recognition mode is operated, and may further include on/off information indicating whether a voice recognition mode is operated.

More specifically, the input interface 210 may receive selection information for an external device for communication with the display device 1.

The external device may include a set-top box, the user device, and a mobile storage device (e.g., universal serial bus (USB) memory, external hard drive, etc.).

The input interface 210 may receive selection information for at least one content among a plurality of contents.

The plurality of contents may include a plurality of contents received through the set-top box, a plurality of contents received through the user device, and a plurality of contents received through the mobile storage device.

The input interface 210 may receive setting information for a panel protection menu.

The panel protection menu may include a pixel shift menu. Setting information for the pixel shift menu may include pixel shift ON information and pixel shift OFF information. The pixel shift menu provides a function of displaying an image by moving pixels at regular intervals when set to pixel shift ON.

The input interface 210 may include a tact switch, a push switch, a slide switch, a toggle switch, a micro switch, a touch switch, a touch pad, a touch screen, a jog dial, a microphone, and the like.

The input interface 210 may include a remote controller that wirelessly communicates with the display device 100.

The communication circuitry 220 may communicate with an external device. The communication circuitry 220 may transmit image information received from the external device in communication to the panel processor 240.

The external device may include a user device, a home appliance, a server, a set-top box, and a mobile storage device.

The communication circuitry 220 may include at least one of a short-range wireless communication module or a long-range wireless communication module.

The communication circuitry 220 may transmit data to an external device or receive data from an external device. For example, the communication circuitry 220 may establish communication with an external device, and transmit and receive various data.

To this end, the communication circuitry 220 may support establishment of a direct (e.g., wired) communication channel or a wireless communication channel between external devices, and communication through the established communication channel.

According to an embodiment, the communication circuitry 220 may include a wireless communication module (e.g., a cellular communication module, a short-range wireless communication module, or a global navigation satellite system (GNSS) communication module) or a wired communication module (e.g., a local area network (LAN) communication module, or a power line communication module).

A corresponding communication module among these communication circuitry 220 may communicate with an external device via a first network (e.g., a short-range communication network such as Bluetooth, wireless fidelity (Wi-Fi) direct, or infrared data association (IrDA)) or a second network (e.g., a long-range communication network such as a legacy cellular network, a 5G network, a next-generation communication network, the Internet, or a computer network (e.g., LAN or WAN)). These various types of communication modules may be integrated into one component (e.g., a single chip) or may be implemented as a plurality of components (e.g., a plurality of chips) separate from each other.

The short-range wireless communication module may include a Bluetooth communication module, a Bluetooth low energy (BLE) communication module, a near field communication module, a WLAN (Wi-Fi) communication module, a Zigbee communication module, an infrared (IrDA) communication module, a Wi-Fi direct (WFD) communication module, an ultrawideband (UWB) communication module, an Ant+ communication module, a microwave (uWave) communication module, etc., but is not limited thereto.

The power supply 230 may receive external commercial power, may convert the received commercial power into power, voltage, and current required for operations of various components provided in the display device, and may deliver the converted power, voltage, and current to various components.

The power supply 230 may supply power to the input interface 210, the communication circuitry 220, the panel processor 240, and the display panel 100c, and the like.

The panel processor 240 may control overall operations of the display device.

The panel processor 240 may control wake-up based on a user input received via the input interface 210 during the sleep mode, and may then control switching to the normal display mode.

The panel processor 240 may convert an image signal received from an external device into a driving signal for each pixel based on the normal display mode, and transmit the converted driving signal for each pixel to the display driver 160.

The driving signal for each pixel may include a voltage signal for each pixel.

The panel processor 240 may control switching to the sleep mode based on a user input received via the input interface 210 during the normal display mode.

The panel processor 240 may determine whether to operate the AOD mode based on whether the AOD mode is set after switching to the sleep mode.

The panel processor 240 may obtain an image for the AOD mode based on setting ON information of the AOD mode, and transmit an image signal for the obtained image to the display driver 160.

The panel processor 240 may determine whether a timing for entering an update mode has been reached during the AOD mode, and transmit an image signal for an update image to the display driver 160 based on determining that the timing for entering the update mode has been reached.

The panel processor 240 may determine whether a timing for entering a blank mode has been reached during the AOD mode, and control operation of the blank mode based on determining that the timing for entering the blank mode has been reached.

The panel processor 240 may reduce power consumption in the AOD mode by reducing (down) power supplied to the panel processor 240 and the display driver 160 in the AOD mode, or by lowering a frequency of a frame rate in the AOD mode than a frequency of a frame rate in the normal display mode.

TABLE 1

| | |
|---|---|
| Normal display mode | AOD mode |

| Frequency of | Power | Frequency of | Power |
|---|---|---|---|
| frame rate | control | frame rate | control |
| 120 Hz | Maintain | 120 Hz | Down |
| 120 Hz | Maintain | 60 Hz | Maintain |
| 120 Hz | Maintain | 60 Hz | Down |
| 60 Hz | Maintain | 60 Hz | Down |

Power control for each mode is described in more detail with reference to Table 1 above.

During the normal display mode, the panel processor 240 may transmit an image signal to the display driver 160 at a first frame rate and maintain power supplied to the panel processor 240 and the display driver 160. During the AOD mode, the panel processor 240 may transmit an image signal to the display driver 160 at the first frame rate and reduce power supplied to the panel processor 240 and the display driver 160. During the update mode, the panel processor 240 may restore power supplied to the panel processor 240 and the display driver 160 and transmit an image signal to the display driver 160 at the first frame rate. In this case, a frequency corresponding to the first frame rate may be 120 Hz.

During the normal display mode, the panel processor 240 may transmit an image signal to the display driver 160 at a second frame rate and maintain power supplied to the panel processor 240 and the display driver 160. During the AOD mode, the panel processor 240 may transmit an image signal to the display driver 160 at the second frame rate and reduce power supplied to the panel processor 240 and the display driver 160. During the update mode, the panel processor 240 may restore power supplied to the panel processor 240 and the display driver 160 and transmit an image signal to the display driver 160 at the second frame rate. In this case, a frequency corresponding to the second frame rate may be 60 Hz.

In a case where frequencies of frame rates of the normal display mode and the AOD mode are the same, the panel processor 240 may reduce power consumption in the AOD mode by reducing power supplied to the panel processor 240 and the display driver 160 in the AOD mode.

During the normal display mode, the panel processor 240 may transmit an image signal to the display driver 160 at the first frame rate and maintain power supplied to the panel processor 240 and the display driver 160. During the AOD mode, the panel processor 240 may transmit an image signal to the display driver 160 at the second frame rate and maintain power supplied to the panel processor 240 and the display driver 160. The first frequency may be 120 Hz, and the second frequency may be 60 Hz.

The panel processor 240 may reduce power consumption in the AOD mode simply by lowering the frequency of the frame rate.

During the normal display mode, the panel processor 240 may transmit an image signal to the display driver 160 at the first frame rate and maintain power supplied to the panel processor 240 and the display driver 160. During the AOD mode, the panel processor 240 may transmit an image signal to the display driver 160 at the second frame rate and reduce power supplied to the panel processor 240 and the display driver 160. A frequency corresponding to the first frame rate may be 120 Hz, and a frequency corresponding to the second frame rate may be 60 Hz.

The panel processor 240 may maximally reduce power consumption in the AOD mode by lowering the frequency of the frame rate and reducing power in the AOD mode.

The panel processor 240 may transmit an image signal to the display driver 160 at a third frame rate based on determining that the timing for entering the blank mode has been reached during the AOD mode.

A frequency corresponding to the third frame rate may be 1 Hz or 0.1 Hz.

The display device 100 may further include a human body detection sensor (not shown).

The human body detection sensor may include a thermal infrared sensor, a motion sensor, and a microphone, and the like. However, the human body detection sensor is not limited thereto, and may include various sensors capable of detecting a human body.

During the AOD mode, the panel processor 240 may recognize a user based on information received from the human body detection sensor (not shown), and may operate the update mode based on determining that the user is recognized.

The panel processor 240 may also control the power supply 230 to supply power to the human body detection sensor during the AOD mode.

During the AOD mode, the panel processor 240 may recognize a voice received through the microphone, identify a user based on the recognized voice, obtain notification information selected by the identified user, and control the update mode based on the obtained notification information.

When a motion is recognized during the AOD mode, the panel processor 240 may obtain notification information corresponding to the recognized motion, and control the update mode based on the obtained notification information.

The panel processor 240 may maintain power supplied to the communication circuitry 230 during the AOD mode, and based on receiving event information from the home appliance 10 through the communication circuitry 230, may determine that a timing for entering the update mode has been reached, may control operation of the update mode, and may control the display panel such that an image corresponding to the event information is displayed as an image of the AOD mode in the update mode.

The panel processor 240 may also maintain power supplied to the communication circuitry 230 during the AOD mode, and based on receiving a communication signal of the user device 2 through the communication circuitry 230, may recognize that a user exists. In this case, the panel processor 240 may determine that a timing for entering the update mode has been reached based on determining that the user is recognized, may control operation of the update mode, and may update an image displayed in the AOD mode through the update mode.

The panel processor 240 may maintain power supplied to the communication circuitry 230 during the AOD mode, and based on receiving content information through the communication circuitry 230, may determine that a timing for entering the update mode has been reached, may control operation of the update mode, and may control the display panel such that an image corresponding to the content information is displayed as an image of the AOD mode during the update mode.

The panel processor 240 may perform the aforementioned operations by using data stored in the memory 250.

The panel processor 240 may include hardware such as a central processing unit (CPU) or a memory, and software such as a control program. For example, the panel processor 240 may include at least one memory that stores data in the form of an algorithm or program for controlling operations of components in the display device, and one or two or more processor chips or one or two or more processing cores that perform the aforementioned operations by using the data stored in the at least one memory.

The panel processor 240 may include a separate neural network processing unit (NPU) that performs an operation of an artificial intelligence model, and may include a graphic processing unit (GPU), or the like.

The memory 250 may store information about an image to be displayed in the AOD mode. The image stored in the memory 250 may be an image selected by a user, and may include a still image.

The memory 250 may also store information about a notification to be displayed in the AOD mode. The notification stored in the memory 250 may be a notification selected by a user, and may include a still image.

An image to be displayed in the AOD mode and a notification to be displayed in the AOD mode will be collectively referred to as a still image.

The memory 250 may also store information about an update cycle of a still image to be displayed in the AOD mode.

The memory 250 may store data for an algorithm or program reproducing the algorithm for controlling operations of components in the display device.

The memory 250 and the panel processor 240 may be implemented as separate chips. Alternatively, the memory 250 and the panel processor 240 may be implemented as a single chip.

The memory 250 may be implemented as at least one of non-volatile memory devices, such as cache, read only memory (ROM), programmable ROM (PROM), erasable programmable ROM (EPROM), electrically erasable programmable ROM (EEPROM), and flash memory, or volatile memory devices such as random access memory (RAM), or storage medium such as a hard disk drive (HDD) and a CD-ROM, but is not limited thereto.

Hereinafter, control configurations of the panel processor 240 are described by dividing the control configurations into a control configuration performed in a first processor 241 and a control configuration performed in a second processor 242.

As shown in FIG. 7, the panel processor 240 may include the first processor 241 and the second processor 242.

The first processor 241 may be an application processor (AP).

The first processor 241 may transmit a user input received via the input interface 210 to the second processor 242.

The user input may include selection information for any one of the normal display mode, the sleep mode, the AOD mode, the voice recognition mode, and the user recognition mode.

The first processor 241 may also transmit, to the second processor 242, information about a frame rate for outputting image data in each of the normal display mode, the AOD mode, the update mode, and the blank mode.

The first processor 241 may determine whether timings for entering the update mode and the blank mode have been reached, and transmit mode entry information about the determined timings for entering the blank mode and the update mode to the second processor 242.

The first processor 241 may determine that the timing for entering the blank mode has been reached based on completion of transmission of an image to be displayed in the AOD mode.

The first processor 241 may receive an image signal from an external device based on operation of the normal display mode, and transmit the received image signal to the second processor 242.

The external device may include at least one of a server, user device, home appliance, set-top box, or mobile storage device.

The first processor 241 may perform signal processing on the received image signal.

The first processor 241 may encode image data corresponding to the received image signal in a designated manner, and transmit the encoded image to the second processor 242.

The first processor 241 may determine whether the AOD mode is set based on entry into the sleep mode, and transmit a still image to the second processor 242 based on determining that the AOD mode is set.

The first processor 241 may transmit, to the second processor 242, an image signal for an image to be displayed in the AOD mode based on operation of the AOD mode. The image may be selected by a user.

The first processor 241 may transmit information about a notification to be displayed in the AOD mode to the second processor 242. The information about notification may include at least one of OTT content information, broadcasting program information, news information, schedule information of a user, operation information of a home appliance, or event information of a home appliance.

The first processor 241 may determine whether a timing for entering the update mode has been reached during the AOD mode, and may transmit an image signal for an update image to the second processor 242 based on determining that the timing for entering the update mode has been reached.

The first processor 241 may determine whether a timing for entering the blank mode has been reached during the AOD mode, and may transmit the third frame rate to the second processor 242 based on determining that the timing for entering the blank mode has been reached.

The first processor 241 may reduce power applied to components in the first processor 241 based on entry into the blank mode during the AOD mode, and may restore power applied to the components in the first processor 241 based on entry into the update mode during the AOD mode.

The first processor 241 may determine that the timing for entering the update mode has been reached based on recognition of a user during the AOD mode.

The first processor 241 may determine that the timing for entering the update mode based on receiving event information from an external device. As shown in FIG. 8, the first processor 241 may include a central processing unit 241a, a graphic processing unit 241b, a display controller 241c, an encoder 241d, a first communication interface 241e, and a first power controller 241f.

The central processing unit (CPU) 241a may control overall operations of the first processor 241. In particular, the CPU 241a may also perform functions of the graphic processing unit 241b.

The graphic processing unit (GPU) 241b may perform image processing on an image output to the display panel 100c, and may transmit image data for the processed image to the display controller 241c.

The display controller 241c may control the display driver 160.

The display controller 241c may generate image data to be transmitted to the display driver 160 based on the received image data. For example, the display controller 241c may generate image data based on the first frame rate based on the normal display mode, and generate image data based on the second frame rate based on the AOD mode.

A frequency corresponding to the first frame rate is referred to a first frequency, and a frequency corresponding to the second frame rate is referred to as a second frequency.

The first frequency may be higher than the second frequency. For example, the first frequency may be 120 Hz, and the second frequency may be 60 Hz.

The display controller 241c may also generate image data based on the third frame rate based on entry into the blank mode.

A frequency corresponding to the third frame rate is referred to as a third frequency.

The third frequency may be lower than the first and second frequencies. For example, the third frequency may be 1 Hz or 0.1 Hz.

The encoder 241d may encode image data transmitted from the first processor 241 to the display driver 160.

The encoder 241d may encode image data in a predesignated manner.

Through the above, image data generated in the display controller 241c may be compressed. The first power controller 241f is turned off the CPU 241a, the GPU 241b, the display controller 241c, the encoder 241d, and the first communication interface 241e based on entry into the update mode, and is turned the CPU 241a, the GPU 241b, the display controller 241c, the encoder 241d, and the first communication interface 241e based on entry into the AOD mode.

Turning off power may include cutting off power.

A timing at which power supplied to the CPU 241a, the GPU 241b, the display controller 241c, the encoder 241d, and the first communication interface 241e is turned off based on entry into the AOD mode may be the timing for entering the blank mode.

The timing for entering the blank mode may be a timing at which transmission of an image to be displayed in the AOD mode is completed.

The first power controller 241f may determine whether a timing for entering the update mode has been reached during the AOD mode, and may control wake-up of the CPU 241a, the GPU 241b, the display controller 241c, the encoder 241d, and the first communication interface 241e based on determining that the timing for entering the update mode has been reached.

Because only power supplied to the first power controller 241f is turned on and power supplied to the CPU 241a, the GPU 241b, the display controller 241c, the encoder 241d, and the first communication interface 241e is turned off during the AOD mode, power supplied to the first processor 241 during the AOD mode may be reduced compared to power supplied during the normal display mode.

Because power supplied to the CPU 241a, the GPU 241b, the display controller 241c, the encoder 241d, the first communication interface 241e, and the first power controller 241f is turned on during the update mode, the first processor 241 may be restored to power of the normal display mode during the update mode.

The second processor 242 may receive an image signal from the first processor 241, convert the received image signal into a driving signal, and transmit the converted driving signal to the display driver 160.

The driving signal may include a data signal and a scan signal.

The driving signal may include a voltage signal.

The second processor 242 may perform signal processing on the received image signal, and may transmit the signal-processed image data to the display driver 160 at the received frame rate.

The second processor 242 may generate a data signal based on the received image signal, transmit the generated data signal to the first driver 161, generate a scan signal based on the received image signal, and transmit the generated scan signal to the second driver 162.

The second processor 242 may receive a display mode from the first processor.

The second processor 242 may control image display in the normal display mode based on the received display mode being the normal display mode, may control image display in the AOD mode based on the received display mode being the AOD mode, and may allow an image displayed in the AOD mode to be updated based on the received display mode being the update mode.

The second processor 242 may receive a frame rate for each mode for outputting image from the first processor 141, and may transmit the received frame rate for each mode to the display driver 160.

Frame rates in the normal display mode and the AOD mode may be the same or different.

More specifically, the second processor 242 may allow an image to be displayed at the first frame rate based on operation of the normal display mode, and allow an image to be displayed at the first frame rate based on operation of the AOD mode.

The second processor 242 may allow an image to be displayed at the second frame rate based on operation of the normal display mode, and allow an image to be displayed at the second frame rate based on operation of the AOD mode.

The second processor 242 may allow an image to be displayed at the first frame rate based on operation of the normal display mode, and allow an image to be displayed at the second frame rate based on operation of the AOD mode.

Frame rates in the AOD mode and the blank mode may be different, and frame rates in the AOD mode and the update mode may be the same.

As shown in FIG. 9, the second processor 242 may allow an image to be displayed at the second frequency corresponding to the second frame rate based on operation of the AOD mode, may allow an image to be displayed at the third frequency corresponding to the third frame rate based on operation of the blank mode, and may allow an image to be displayed at the second frequency corresponding to the second frame rate based on operation of the update mode.

The second processor 242 may turn on power supplied to various components provided in the second processor 242 based on operation of the normal display mode.

Turning on power supplied to various components provided in the second processor 242 may include supplying power required for driving of each of the various components provided in the second processor 242.

The second processor 242 may reduce power applied to components in the second processor 242 based on entry into the blank mode during the AOD mode, and may restore power applied to the components in the second processor 242 based on entry into the update mode during the AOD mode.

Restoring power applied to the components in the second processor 242 may include increasing power supplied to the components in the second processor 242 by an amount corresponding to the reduced power.

Information about entry into the update mode may be received from the first processor 241.

The second processor 242 may control power supplied to the display driver 160 based on operation of the normal display mode.

The second processor 242 may reduce power applied to the display driver 160 based on entry into the blank mode during the AOD mode, and may restore power applied to the display driver 160 based on entry into the update mode during the AOD mode.

The second processor 242 may reduce power simultaneously with the first processor 241 based on operation of the AOD mode.

The second processor 242 may reduce power of the second processor after a preset time has elapsed from a timing at which power of the first processor 241 is reduced based on operation of the AOD mode.

As shown in FIG. 10, the second processor 242 may include a second communication interface 242a, a communication controller 242b, a memory controller 242c, a low-power memory 242d, a decoder 242e, a scaler 242f, an image processor 242g, a timing controller 242h, and a second power controller 242i.

The second communication interface 242a may receive an image signal from the first communication interface of the first processor.

The second communication interface 242a may receive a user input from the first communication interface of the first processor.

The second communication interface 242a may include a physical communication terminal.

The second communication interface 242a may perform Vx1 and USB communication.

The communication controller 242b may interface signals and image data transmitted or received between the first processor and the display driver 160.

The communication controller 242b may transmit an image signal transmitted from the first processor to the memory controller 242c, and transmit a user input transmitted from the first processor to the timing controller.

The user input may include an entry command for the sleep mode and an entry command for the normal display mode, and may include a setting command for the AOD mode, and the like.

The communication controller 242b may transmit a control command transmitted from the first processor 241 to the timing controller. The control command may include an entry command for the update mode and an entry command for the AOD mode.

In a case where a command controller is provided in the second processor, the command controller may receive at least one of a user input or a control signal, and may transmit at least one of the received user input or control signal to the timing controller 242h.

The memory controller 242c may receive an image signal transmitted from the communication controller 242b, and may control an operation of writing image data for the received image signal to the low-power memory 242d.

The memory controller 242c may control an operation of writing image data to the low-power memory 242d based on a received frame rate.

The low-power memory 242d may store image data transmitted from the memory controller 242c based on a control signal of the memory controller 242c.

The image data may include image data for a still image or moving image to be displayed during the normal display mode.

The image data may include image data for a still image displayed during the AOD mode.

The low-power memory 242d may store image data at the received frame rate. The stored image data may include image data compressed by encoding or uncompressed image data.

The low-power memory 242d may have a different update frequency or speed depending on an image type output to the display panel 100c. For example, during moving image playback, image data corresponding to a frame of the moving image may be written to the low-power memory 242d at a designated speed. In a case of a still image, the low-power memory 242d may store the still image until the still image is updated.

Image data stored in the low-power memory 242d may be transmitted to the decoder 242e.

The decoder 242e may decode the received image data, and may transmit the decoded image data to the timing controller 242h.

When uncompressed image data is received from the first processor, the low-power memory may transmit the stored image data to the timing controller 242h.

In a case where a scaler and an image processor are provided, the decoder 242e may transmit the decoded image data to the scaler 242f. In this case, the scaler 242f may enlarge the decoded image by a designated magnification.

The scaler 242f may be an up-scaler and may increase the number of pixels included in image data. For example, the scaler 242f may increase the number of pixels included in a high definition (HD) image to the number of pixels corresponding to a full HD (FHD) image.

The image processor 242g may perform image processing on image data, and may transmit the processed image data to the timing controller 242h.

The image processor 242g may improve image quality of image data. For example, the image processor 242g may include a pixel data processing circuit, a pre-processing circuit, and a gating circuit, and the like.

The timing controller 242h may supply a synchronizing signal or a clock signal to the display driver 160. In addition, the timing controller 242h may transmit a read command (RCMD) for a read operation of the low-power memory 242d to the memory controller 242c.

The synchronizing signal or the clock signal supplied from the timing controller 242h may be used for tearing effect (TE) output. Image data may be synchronized with a TE signal, and the synchronized image data may be transmitted to the display driver 160.

The timing controller 242h may control such that the processed image data is sequentially shifted. The shifted image data may be output to the display panel 100c through the first driver 161.

The timing controller 242h may control operation timing of each component provided in the second processor 242.

For example, the timing controller 242h may adjust a timing for storing the image data corresponding to the image signal received from the first processor 241 in the low-power memory 242d and a timing for reading image data stored in the low-power memory 242d so that the storing and the reading do not overlap each other.

The timing controller 242h may read image data stored in the low-power memory 242d at a designated frame rate, and may control timings for delivering the image data to the decoder 242e and the scaler 242f.

The timing controller 242h may deliver image data received from the image processor 242g to the first driver 161, and may control output of a scan signal of the second driver 162.

The timing controller 242h may include a dynamic frame frequency controller (DFFC) that converts to a frequency corresponding to the received frame rate.

The DFFC (not shown) may determine a frame rate of image data stored in the low-power memory 242d.

The DFFC (not shown) may receive information related to a frame rate from the second communication interface 242a, and may control a read speed and an output speed of image data stored in the low-power memory 242d based on the received information related to the frame rate and a timing signal.

During the normal display mode, the timing controller 242h may switch the normal display mode to the sleep mode and the AOD mode based on a control signal of the first processor 241, and may be woken up by the second power controller 242h during the sleep mode.

The timing controller 242h may be woken up by the second power controller 242h during the AOD mode to control the update mode, and during the update mode, may switch the update mode to the AOD mode based on a control signal of the first processor 241.

The second power controller 242i may be a part of the power supply 230. The second power controller 242i may also receive power from the power supply 230.

The second power controller 242i may receive power from the power supply 230 during the normal display mode, the sleep mode, the AOD mode, the update mode, and the blank mode.

The second power controller 242i may supply power required for driving of components of the second processor 242, that is, the second communication interface 242a, the communication controller 242b, the memory controller 242c, the low-power memory 242d, the decoder 242e, the scaler 242f, the image processor 242g, and the timing controller 242h, based on operation of the normal mode.

The second power controller 242i may turn off power supplied to the second communication interface 242a, the communication controller 242b, the memory controller 242c, the low-power memory 242d, the decoder 242e, the scaler 242f, the image processor 242g, and the timing controller 242h at the timing for entering the AOD mode.

Here, turning off power may include cutting off power.

Because only power supplied to the second power controller 242i is turned on and power supplied to the second communication interface 242a, the communication controller 242b, the memory controller 242c, the low-power memory 242d, the decoder 242e, the scaler 242f, the image processor 242g, and the timing controller 242h is turned off during the AOD mode, total power supplied during the AOD mode may be reduced compared to total power supplied during the normal display mode.

The second power controller 242i may also maintain power supplied to the second power controller 242i at the timing for entering the AOD mode, and may reduce power supplied to the second power controller 242i at the timing for entering the blank mode during the AOD mode. Accordingly, power consumed in the second processor 242 during the AOD mode may be minimized.

The second power controller 242i may also maintain power supplied to the second power controller 242i at the timing for entering the AOD mode, and may reduce power supplied to the second power controller 242i when a self refresh function using the low-power memory is completed.

In this case, the low-power memory 242c of the second processor 242 may transmit, to the display driver 160, image data stored through the self refresh function, and allow a still image to be displayed through the display panel 100c for a predetermined time.

The second power controller 242i may turn on power supplied to the second communication interface 242a, the communication controller 242b, the memory controller 242c, the low-power memory 242d, the decoder 242e, the scaler 242f, the image processor 242g, and the timing controller 242h at the timing for entering the update mode.

Because power supplied to the second communication interface 242a, the communication controller 242b, the memory controller 242c, the low-power memory 242d, the decoder 242e, the scaler 242f, the image processor 242g, and the timing controller 242h is turned on during the update mode, power supplied to the second processor 242 during the update mode may be restored to power supplied in the normal display mode.

The second power controller 242i may control wake-up of the second communication interface 242a, the communication controller 242b, the memory controller 242c, the low-power memory 242d, the decoder 242e, the scaler 242f, the image processor 242g, and the timing controller 242h based on determining that the timing for entering the update mode has been reached.

The second power controller 242i may supply a reference power to the display driver 160 during the blank mode so that the display panel 100c operates at a preset reference luminance.

In a case of the display driver 160, power supplied to the display driver 160 may be maintained before entry into the blank mode, and power supplied to the display driver 160 may decrease to the reference power after entry into the blank mode.

Supplying the reference power to the display driver 160 includes supplying minimum power required for driving to power terminals (V_{DD}, V_{SS}, Gate off, etc.) of thin film transistors. Here, the minimum power required for driving the thin film transistors may be information obtained through testing and pre-stored.

The second power controller 242i may restore power supplied to the second power controller 242i based on entry into the update mode.

A configuration for power control of the second processor and the display driver in the AOD mode is shown in the table below.

TABLE 2

| | | Second processor | | |
|---|---|---|---|---|
| | | Second power | Remaining | Display |
| | | controller | components | driver |
| AOD | Before entry | Maintain | Power | Maintain |
| mode | into blank mode | power | off | power |
| | After entry | Decrease to | Power | Decrease to |
| | into blank mode | reference | off | reference |
| | | power | | power |

FIG. 11 is a table of power consumption of the display device according to an embodiment.

More specifically, FIG. 11 shows, in the AOD mode, an amount of power consumption and a total amount of power consumption in the power supply 230, the first and second processors 241 and 242, and the display panel 100c when an image is output at the second frame rate, an amount of power consumption and a total amount of power consumption in the power supply 230, the first and second processors 241 and 242, and the display panel 100c when an image is output at the third frame rate, and an amount of power consumption and a total amount of power consumption in the power supply 230, the first and second processors 241 and 242, and the display panel 100c when an image is output at the third frame rate and power supplied to the power supply 230 and the first and second processors 241 and 242 is reduced.

As shown in FIG. 11, it may be seen that the amount of power decreases when the frame rate for outputting an image is decreased, and the amount of power further decreases when the frame rate for outputting an image is decreased and power is reduced.

At least one component may be added or omitted corresponding to performance of components of the display device shown in FIGS. 4, 5, 8, and 10. In addition, it will be easily understood by those skilled in the art that mutual positions of components may be modified corresponding to performance or structure of a system.

Meanwhile, each component shown in FIGS. 4, 5, 8, and 10 refers to software and/or hardware components such as a field programmable gate array (FPGA) and an application specific integrated circuit (ASIC).

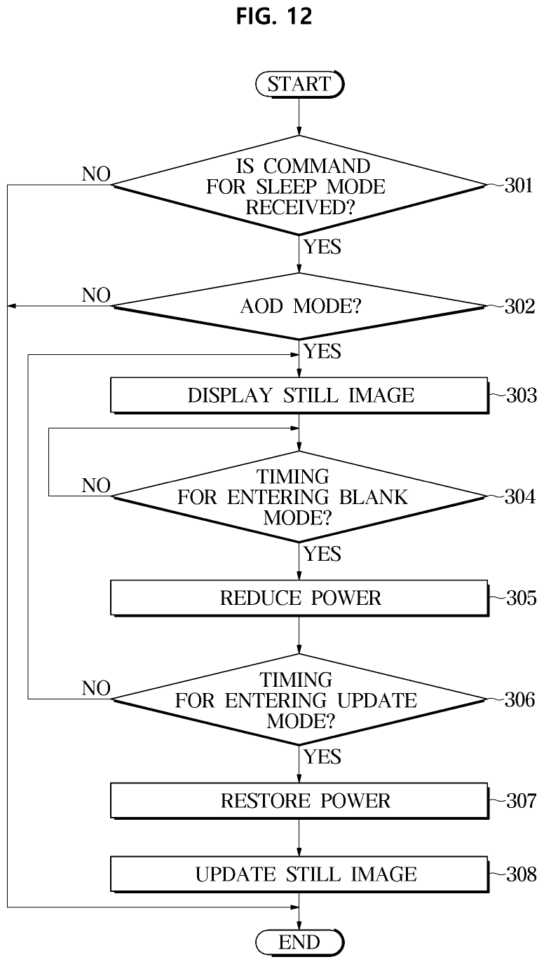

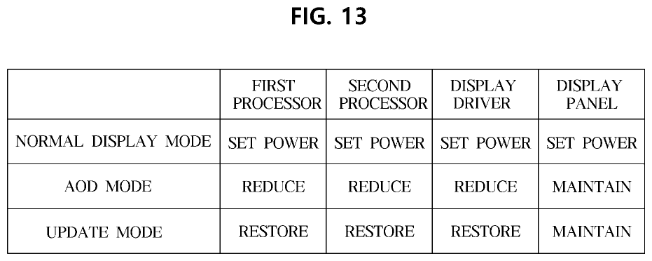

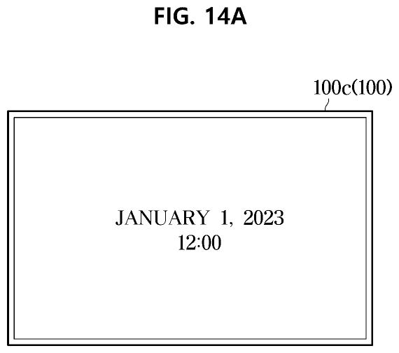

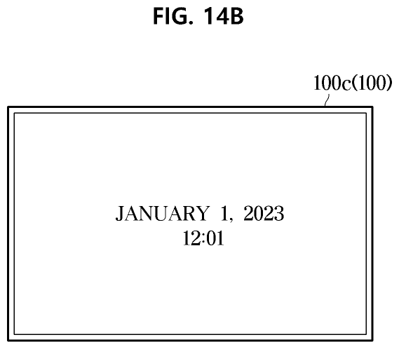

FIG. 12 is a flowchart illustrating a method for controlling a display device according to an embodiment, which is described with reference to FIGS. 13, 14A, and 14B.

FIG. 13 is a power control table of the first processor 241, the second processor 242, the display driver 160, and the display panel 100c for each mode of the display device according to an embodiment.

FIG. 14A and FIG. 14B are views illustrating examples of an image displayed in an AOD mode of the display device according to an embodiment.

The display device may output an image based on the first frame rate or the second frame rate during the normal display mode.

A frequency corresponding to the first frame rate may be higher than a frequency corresponding to the second frame rate.

As shown in FIG. 13, the display device may supply set power to each of the first processor 241, the second processor 242, the display driver 160, and the display panel 100c during the normal display mode.

The set power supplied to each of the first processor 241, the second processor 242, the display driver 160, and the display panel 100c in the normal display mode may be the same as each other or different from each other.

The display device may determine whether a command for the sleep mode is received during the normal display mode (301), and may switch from the normal display mode to the sleep mode based on determining that the command for the sleep mode is received.

The display device may determine whether the AOD mode is set based on switching to the sleep mode (302).

The display device may control the AOD mode to not operate based on setting information of the AOD mode being OFF information.

The display device may control the AOD mode to operate based on the setting information of the AOD mode being ON information.

The display device may allow a still image to be displayed through the display panel based on controlling operation of the AOD mode (303).

Controlling operation of the AOD mode includes transmitting the still image stored in the first processor 241 to the second processor 242 at a timing for entering the AOD mode.

Controlling operation of the AOD mode includes transmitting the received still image to the display driver 160 when the still image is received in the second processor 242.

The display driver may transmit a driving signal corresponding to the received still image to the display panel 100c, thereby allowing the still image to be displayed through the display panel.

The still image may include an image selected by a user.

The image selected by the user may include images including photos and emoticons.

The still image may include an image for a notification selected by a user.

The notification may include a notification for date and time, a notification for weather, a notification for an event of a home appliance, a notification for news, a notification for a schedule of a user, a notification for an event of a user device, a notification for new content, a notification for a broadcasting program, and the like.

The display device may output an image based on the first frame rate or the second frame rate during the AOD mode.

A frequency corresponding to the first frame rate may be higher than a frequency corresponding to the second frame rate.

A frequency of a frame rate of a still image displayed during the AOD mode may be the same as or lower than a frequency of a frame rate of an image displayed during the normal display mode.

As shown in FIG. 14A, in a case where a notification selected by a user is a notification for date and time, the display device may display the date and time during the AOD mode.

During the AOD mode, the display device may determine whether a timing for entering the blank mode has been reached (304), and reduce power supplied to the first and second processors 241 and 242 and the display driver 160 based on determining that the timing for entering the blank mode has been reached (305).

In addition, during the blank mode, the display device may output a still image at the same frame rate as during the AOD mode.

In addition, the display device may output a still image at the third frame rate during the blank mode. Here, a frequency corresponding to the third frame rate may be lower than frequencies corresponding to the first and second frame rates.

Determining whether the timing for entering the blank mode has been reached may include determining whether transmission of an image signal for a still image, stored in the first processor 241, to the second processor 242 and the display driver 160 is completed.

That is, the display device may display the still image through the display panel during the AOD mode, and then reduce power supplied to the first and second processors 241 and 242 and the display driver 160. In this instance, the display device may maintain power supplied to the display panel 100c at the set power.

The power reduction (power down) configuration is described with reference to FIG. 13.

The display device may reduce power supplied to the first processor 241 when transmission of the image signal for the still image from the first processor 241 to the second processor 242 is completed.

Reducing power supplied to the first processor 241 may include turning off power supplied to the CPU 241a, the GPU 241b, the display controller 241c, the encoder 241d, and the first communication interface 241e, and turning on power supplied to the first power controller 241f.

As such, by turning on only power supplied to the first power controller 241f and turning off power supplied to the remaining components of the first processor during the AOD mode, total power supplied to the first processor 241 in the AOD mode may be reduced compared to total power supplied from the first processor 241 during the normal display mode.

The display device may reduce power supplied to the second processor 242 when transmission of a driving signal for a still image from the second processor 242 to the display driver 160 is completed.

Reducing power supplied to the second processor 242 may include turning off power supplied to the second communication interface 242a, the communication controller 242b, the memory controller 242c, the low-power memory 242d, the decoder 242e, the scaler 242f, the image processor 242g, and the timing controller 242h, and turning on power supplied to the second power controller 242i.

As such, by turning on only power supplied to the second power controller 242i and turning off power supplied to the remaining components of the second processor during the AOD mode, total power supplied to the second processor 242 in the AOD mode may be reduced compared to total power supplied from the second processor 242 during the normal display mode.

The low-power memory 242d of the second processor may perform a self refresh function from an entry timing for the AOD mode until before entry into the blank mode, and may transmit the driving signal for the still image to the display driver 160 while the self refresh function is performed.

The display device may reduce power supplied to the second processor 242 when the self refresh function of the low-power memory 242d of the second processor 242 is completed.

The display device may also reduce power supplied to the second processor 242 at the timing for entering the AOD mode, supply preset power to the low-power memory of the second processor 242, and reduce power supplied to the remaining components of the second processor 242 that controls the second power controller 242i.

The preset power may be power required for the low-power memory 242d to perform the self refresh function.

The display device may reduce power supplied to the display driver 160 when transmission of the driving signal for the still image from the display driver 160 to the display panel 100c is completed.

Reducing power supplied to the display driver 160 includes supplying the thin film transistors of the display panel 100c with a reference power required for driving thin film transistors.

As such, by supplying only the reference power required for driving the thin film transistors to the thin film transistors of the display panel 100c, total power supplied to the display driver 160 in the AOD mode may be reduced compared to total power supplied to the display driver 160 in the normal display mode.

The display device may determine whether a timing for entering the update mode has been reached during the blank mode (306), and restore power supplied to the first and second processors 241 and 242 and the display driver 160 based on determining that the timing for entering the update mode has been reached (307). In this instance, the display device may maintain power supplied to the display panel 100c at the set power.

Determining whether the timing for entering the update mode has been reached may include recognizing whether a user exists around the display device and determining that the timing for entering the update mode has been reached based on recognizing the user.

Determining whether the timing for entering the update mode has been reached may include determining whether a current timing corresponds to a pre-stored update cycle, and determining that the timing for entering the update mode has been reached based on determining that the current timing corresponds to the pre-stored update cycle.

Determining whether the timing for entering the update mode has been reached may include determining whether the timing for entering the update mode has been reached based on whether information corresponding to a notification is received. For example, the information corresponding to a notification may include event information from a home appliance, broadcasting program information, event information of a user device, new OTT content information, and the like.

Determining whether the timing for entering the update mode has been reached may include determining whether the timing for entering the update mode has been reached based on a change in weather or time.

The power restoration configuration is described with reference to FIG. 13.

Restoring power supplied to the first processor 241 may include waking up the CPU 241a, the GPU 241b, the display controller 241c, the encoder 241d, and the first communication interface 241e of the first processor by turning on power supplied to the CPU 241a, the GPU 241b, the display controller 241c, the encoder 241d, and the first communication interface 241e.

Restoring power supplied to the first processor 241 may include maintaining power supplied to the first power controller 241f in an ON state.

As such, by turning on power supplied to the first power controller 241f and turning on power supplied to the remaining components of the first processor during the update mode, total power supplied to the first processor 241 in the update mode may be restored to the same level as total power supplied from the first processor 241 during the normal display mode.

Restoring power supplied to the second processor 242 may include turning on power supplied to the second communication interface 242a, the communication controller 242b, the memory controller 242c, the low-power memory 242d, the decoder 242e, the scaler 242f, the image processor 242g, and the timing controller 242h of the second processor, and waking up the second communication interface 242a, the communication controller 242b, the memory controller 242c, the low-power memory 242d, the decoder 242e, the scaler 242f, the image processor 242g, and the timing controller 242h.

Restoring power supplied to the second processor 242 may include maintaining power supplied to the second power controller 242i of the second processor in an ON state.

As such, by turning on power supplied to the second power controller 242i and turning on power supplied to the remaining components of the second processor during the update mode, total power supplied to the second processor 242 in the update mode may be restored to the same level as total power supplied from the second processor during the normal display mode.

Restoring power supplied to the display driver 160 includes supplying power supplied to the thin film transistors of the display panel 100c in the normal display mode.

The display device updates a still image (308).

As shown in FIG. 14B, in a case where a notification selected by a user is a notification for date and time, the display device may display the updated date and time during the AOD mode.

During the update mode, the display device may also determine whether setting information of a pixel shift menu is an ON setting of the pixel shift, and may control the pixel shift function based on determining that the setting information of the pixel shift menu is an ON setting of the pixel shift.

During the update mode, the display device may also identify a user, confirm notification information set by the identified user, obtain an update image based on the confirmed notification information, and update an image to be displayed in the AOD mode based on the obtained update image.

The display device may determine that a timing for entering the blank mode has been reached when update of the still image is completed, and may control operation of the blank mode.

The display device may also reduce power supplied to the first processor 241 first during the AOD mode, and may reduce power supplied to the second processor 242 when a preset time has elapsed.

According to an embodiment, a display device includes: a display panel; a display driver electrically connected to the display panel; a panel processor configured to transmit a driving signal to the display driver; and a power supply configured to supply power to the display panel, the display driver, and the panel processor, wherein the panel processor is configured to control the power supply to maintain power supplied to the display panel and reduce power supplied to at least one of the display driver or the panel processor in an always on display (AOD) mode.

The panel processor may include: a first processor configured to receive an image signal from an external device; and a second processor configured to convert the image signal received by the first processor into the driving signal for each pixel and transmit the converted driving signal for each pixel to the display driver.

The first processor may include a central processing unit configured to perform signal processing on the image signal received from the external device, a display controller configured to control transmission of the received image signal, a first communication interface configured to transmit the received image signal to the second processor, and a first power controller configured to control power supplied to the central processing unit, the display controller, and the first power controller, and wherein the first power controller may be configured to receive power from the power supply and block power supplied to the central processing unit, the display controller, and the first power controller in the AOD mode.

The second processor may include a second communication interface configured to communicate with the first processor, a low-power memory configured to store an image, an image processor configured to perform image processing on the received image, a timing controller configured to control operation timing of the low-power memory and the image processor, and a second power controller configured to control power supplied to the second communication interface, the low-power memory, the image processor, and the timing controller, and wherein the second power controller may be configured to receive power from the power supply and block power supplied to the second communication interface, the low-power memory, the image processor, and the timing controller in the AOD mode.

The second power controller may be configured to supply a reference power to the display driver in the AOD mode, and wherein the reference power may be power that provides a luminance of the display panel at a reference luminance in the AOD mode.

The second processor may be configured to control transmission of an image stored in the low-power memory to the display driver based on power supplied to the first processor being reduced.

The first power controller may be configured to maintain power supplied to the central processing unit, the display controller, and the first power controller during the AOD mode, based on setting ON information of a voice recognition mode.

The panel processor may be configured to: control the display driver to output the received image at a first frame rate based on a normal display mode, and control the display driver to output the received image at a second frame rate based on the AOD mode, wherein a frequency corresponding to the second frame rate may be less than or equal to a frequency corresponding to the first frame rate.

The panel processor may be configured to: control the power supply to restore power supplied to the display driver and the panel processor, based on a timing for entering an update mode for updating an image displayed in the AOD mode being reached, and control the display driver to output the received image at the second frame rate based on the update mode.

The display device may include: communication circuitry configured to communicate with a user device and a home appliance, wherein the panel processor may be configured to determine that the timing for entering the update mode is reached based on receiving a communication signal from the user device, and determine that the timing for entering the update mode is reached based on receiving event information from the home appliance.

The display panel may be configured to control a pixel shift during the update mode.

The panel processor may be configured to determine whether a timing for entering a blank mode is reached during the AOD mode, and control the display driver to output a pre-stored image at a third frame rate based on determining that the timing for entering the blank mode is reached, wherein a frequency corresponding to the third frame rate is less than the frequency corresponding to the first frame rate and the frequency corresponding to the second frame rate.

According to an embodiment, a method for controlling a display device, includes: based on an entry into an always on display (AOD) mode, reducing power supplied to at least one of a display driver or a panel processor and maintaining power supplied to a display panel; based on an entry into an update mode, restoring power supplied to at least one of a first processor, a second processor, or the display driver, and maintaining power supplied to the display panel; transmitting, by the first processor, an image signal received from an external device to the second processor; converting, by the second processor, the image signal into a driving signal, and transmitting the driving signal to the display driver; and transmitting, by the display driver, the driving signal to the display panel.

The method may include: outputting the image signal at a first frame rate based on a normal display mode; outputting the image signal at a second frame rate based on the AOD mode; and outputting the image signal at the second frame rate based on the update mode, wherein a frequency corresponding to the second frame rate may be less than or equal to a frequency corresponding to the first frame rate.

The method may include: determining an entry into a blank mode during the AOD mode; and outputting the image signal at a third frame rate based on the entry into the blank mode, wherein a frequency corresponding to the third frame rate may be less than the frequencies corresponding to the first frame rate and the second frame rate.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

What is claimed is:

1. A display device, comprising:
a display panel;
a display driver electrically connected to the display panel;
a panel processor configured to transmit a driving signal to the display driver; and
a power supply configured to supply power to the display panel, the display driver, and the panel processor,
wherein the panel processor is configured to control the power supply to maintain power supplied to the display panel and reduce power supplied to at least one of the display driver or the panel processor in an always on display (AOD) mode.

2. The display device of claim 1, wherein the panel processor comprises:
a first processor configured to receive an image signal from an external device; and
a second processor configured to convert the image signal received by the first processor into the driving signal for each pixel and transmit the converted driving signal for each pixel to the display driver.

3. The display device of claim 2, wherein the first processor comprises a central processing unit configured to perform signal processing on the image signal received from the external device, a display controller configured to control transmission of the received image signal, a first communication interface configured to transmit the received image signal to the second processor, and a first power controller configured to control power supplied to the central processing unit, the display controller, and the first power controller, and
wherein the first power controller is configured to receive power from the power supply and block power supplied to the central processing unit, the display controller, and the first power controller in the AOD mode.

4. The display device of claim 2, wherein the second processor comprises a second communication interface configured to communicate with the first processor, a low-power memory configured to store an image, an image processor configured to perform image processing on the received image, a timing controller configured to control operation timing of the low-power memory and the image processor, and a second power controller configured to control power supplied to the second communication interface, the low-power memory, the image processor, and the timing controller, and
wherein the second power controller is configured to receive power from the power supply and block power supplied to the second communication interface, the low-power memory, the image processor, and the timing controller in the AOD mode.

5. The display device of claim 4, wherein the second power controller is configured to supply a reference power to the display driver in the AOD mode, and
wherein the reference power is power that provides a luminance of the display panel at a reference luminance in the AOD mode.

6. The display device of claim 4, wherein the second processor is configured to control transmission of an image stored in the low-power memory to the display driver based on power supplied to the first processor being reduced.

7. The display device of claim 3, wherein the first power controller is configured to maintain power supplied to the central processing unit, the display controller, and the first power controller during the AOD mode, based on setting ON information of a voice recognition mode.

8. The display device of claim 2, wherein the panel processor is configured to:
control the display driver to output the received image at a first frame rate based on a normal display mode, and
control the display driver to output the received image at a second frame rate based on the AOD mode,
wherein a frequency corresponding to the second frame rate is less than or equal to a frequency corresponding to the first frame rate.

9. The display device of claim 8, wherein the panel processor is configured to:
control the power supply to restore power supplied to the display driver and the panel processor, based on a timing for entering an update mode for updating an image displayed in the AOD mode being reached, and
control the display driver to output the received image at the second frame rate based on the update mode.

10. The display device of claim 9, further comprising:
communication circuitry configured to communicate with a user device and a home appliance,
wherein the panel processor is configured to determine that the timing for entering the update mode is reached based on receiving a communication signal from the user device, and determine that the timing for entering the update mode is reached based on receiving event information from the home appliance.

11. The display device of claim 9, wherein the display panel is configured to control a pixel shift during the update mode.

12. The display device of claim 8, wherein the panel processor is configured to determine whether a timing for entering a blank mode is reached during the AOD mode, and
control the display driver to output a pre-stored image at a third frame rate based on determining that the timing for entering the blank mode is reached,
wherein a frequency corresponding to the third frame rate is less than the frequency corresponding to the first frame rate and the frequency corresponding to the second frame rate.

13. A method for controlling a display device, comprising:
based on an entry into an always on display (AOD) mode, reducing power supplied to at least one of a display driver or a panel processor and maintaining power supplied to a display panel;
based on an entry into an update mode, restoring power supplied to at least one of a first processor, a second processor, or the display driver, and maintaining power supplied to the display panel;
transmitting, by the first processor, an image signal received from an external device to the second processor;
converting, by the second processor, the image signal into a driving signal, and transmitting the driving signal to the display driver; and
transmitting, by the display driver, the driving signal to the display panel.

14. The method of claim 13, further comprising:
outputting the image signal at a first frame rate based on a normal display mode;
outputting the image signal at a second frame rate based on the AOD mode; and
outputting the image signal at the second frame rate based on the update mode,
wherein a frequency corresponding to the second frame rate is less than or equal to a frequency corresponding to the first frame rate.

15. The method of claim 14, further comprising:
determining an entry into a blank mode during the AOD mode; and
outputting the image signal at a third frame rate based on the entry into the blank mode,
wherein a frequency corresponding to the third frame rate is less than the frequencies corresponding to the first frame rate and the second frame rate.
